(19) United States
(12) Patent Application Publication
(10) Pub. No.: US 2018/0288004 A1
(43) Pub. Date: Oct. 4, 2018

(54) METHOD AND APPARATUS FOR COMMUNICATION VIA AN EXTENDED VIRTUAL PERSONAL AREA NETWORK

(71) Applicant: MOTOROLA SOLUTIONS, INC, CHICAGO, IL (US)

(72) Inventors: XUN FEI, CHENGDU (CN); DA-JUN CHEN, CHENGDU (CN); WEN FENG, CHENGDU (CN); YA-HUI GONG, CHENGDU (CN); JUN JIANG, CHENGDU (CN); YONG TIAN, CHENGDU (CN)

(21) Appl. No.: 15/754,019

(22) PCT Filed: Dec. 22, 2015
(86) PCT No.: PCT/CN2015/098349

§ 371 Date: Feb. 21, 2018

(51) Int. Cl. H04L 29/06; H04L 12/46; H04W 76/12

(52) U.S. Cl. CPC H04L 63/0272; H04L 12/4641; H04W 4/80; H04L 63/0884; H04L 63/0853; H04W 76/12

(57) ABSTRACT

A communication system is provided wherein multiple communication devices of a user may collaborate with each other via an extended virtual Personal Area Network (EVPAN). When the user exits his car and leaves one of his collaborative devices in the car, and travels out of Personal Area Network (PAN) range of the device in the car, the communication system provides for the user to take advantage of the collaborative features the device left behind in the car by bridging the PAN with a WAN via an EVPAN server. Further, the communication system provides for collaborative communication devices to communicate with each other without a need for users of such collaborative communication devices to be authenticated. For example, someone picking up a first communication device of a user can connect to a second, collaborative communication device of the user without the person using the first communication device being authenticated.

### FIELD OF THE INVENTION

The present invention relates generally to wireless communication systems, and, in particular, to device collaboration via an extended virtual personal area network (PAN).

### BACKGROUND OF THE INVENTION

Device collaboration is a set of features that allows multiple devices under control of a single user to take advantage of capabilities of the other collaborative devices via a link between them, that is, a collaborative interface. For example, one collaborative device may hop through another device with better connectivity to reach a network service, or one device may access context or other information (such as address book information) on a peer collaborative device. A more specific example would include a Land Mobile Radio (LMR) device and a broadband device. Under non-collaborative operation, the LMR device is not able to access data services that are only available on broadband networks. Through collaboration, the LMR device is able to access broadband data services via the broadband device. More advanced collaborative features would allow user single sign-on (SSO) status to be shared among collaborative devices, or would allow a user to start an application on one device, and pause it and continue on another device.

Collaborative devices have a special relationship with each other in that they can be considered to be working together on behalf of a user. It would not be unreasonable to consider collaborative devices to be a single multiprocessor “virtual device,” with each processor connected by a wireless bus (that is, the collaborative interface).

Personal Area Networks (PANs), such as Bluetooth (BT), are well suited for device collaboration communications. However, PAN technologies, such as BT, require a user to physically pair the devices (for example, via a Personal Identification Number (PIN) entry or a Near Field Communication (NFC) pairing), and, correspondingly, require that the paired devices be proximate to each other. Instances may arise when a user has a number of devices that are capable of collaborative but are sufficiently separated that they no longer can collaborate over the PAN. For example, a public safety officer may exit his car and leave one of his collaborative devices behind, traveling out of PAN range of the device in the car. For a variety of reasons, the user still may want to take advantage of the collaborative features of the device left behind. Further, there are times when it is beneficial for someone wishing to contact a user to be able to use a communication device of the user to reach a collaborative device that is being carried by the user.

### BRIEF DESCRIPTION OF SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in accordance with some embodiments of the present invention.

FIG. 2 is a block diagram of a mobile station of the communication system of FIG. 1 in accordance with some embodiments of the present invention.

FIG. 3 is a block diagram of an extended virtual PAN (EVPAN) server of the communication system of FIG. 1 in accordance with some embodiments of the present invention.

FIG. 4 is a logic flow diagram illustrating a method by which a network-based EVPAN user account may be dynamically created on an EVPAN server of the communication system of FIG. 1 in accordance with some embodiments of the present invention in accordance with some embodiments of the present invention.

FIG. 5 is a logic flow diagram illustrating a method by which the communication system of FIG. 1 sets up a network-based EVPAN in accordance with some embodiments of the present invention.

FIG. 6 is a block diagram of a wireless communication system in accordance with some embodiments of the present invention.

FIG. 7 is a logic flow diagram illustrating a method executed by the communication system of FIG. 6 in creating a super-EVPAN in accordance with some embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION OF THE INVENTION

To address the need for utilizing collaborative features of a first communication device left behind when a user carries a second collaborative communication device out of range of the first communication device, a communication system is provided wherein a user has multiple devices that are collaborative with each other via an extended virtual Personal Area Network (EVPAN). When the user exits his car and leaves one of his collaborative devices in the car, and travels out of Personal Area Network (PAN) range of the device in the car, the communication system provides for the user to take advantage of the collaborative features the device left behind in the car by bridging the PAN with a WAN via an EVPAN server. Further, the communication system provides for collaborative communication devices to communicate with each other without a need for the users of such collaborative communication devices to be authenticated. For example, someone may pick up a first communication device of a user and connect to a second, collaborative communication device of the user, for example, which second communication device is being carried by the user, without the person using the first communication device being required to be authenticated. Additionally, the communication system provides for a connecting of multiple EVPANs to create a super-EVPAN.

Generally, an embodiment of the present invention encompasses a method for bridging a Personal Area Network (PAN) with a wide area network (WAN). The method includes maintaining a user account at a network-based server, wherein the user account comprises an identifier of a user, identifiers for each of a plurality of communication devices of the user, and a state of each communication device of the plurality of communication devices; receiving, by the server, a login attempt by a first communication device of the plurality of communication devices; receiving, by the server from the first communication device, a request to connect to one or more second communication devices of the plurality of communication devices of the user; determining, by the server, a state of each of the one or more second communication devices; and connecting, by the server and based on the determined state of each of the one or more second communication devices, the first communication device to at least one of the one or more second communication devices via the server and without authenticating a user of the first communication device.

Another embodiment of the present invention encompasses a method for bridging a plurality of Personal Area Networks (PANs) with a WAN. The method includes establishing a first extended PAN, wherein the first extended PAN comprises a first set of communication devices that are bridged via the WAN; establishing a second extended PAN, wherein the second extended PAN comprises a second set of communication devices that are bridged via the WAN; determining a first active communication device of the first extended PAN; determining a second active communication device of the second extended PAN; and bridging the first extended PAN and the second extended PAN by bridging the first active communication device with the second active communication device. The first active communication device then relays, to other communication devices of the first set of communication devices and via the WAN, communications received from the second extended PAN, and relays, to the second extended PAN via the WAN, communications received from the other communication devices of the first set of communication devices. Further, the second active communication device then relays, to other communication devices of the second set of communication devices and via the WAN, communications received from the first extended PAN, and relays, to the first extended PAN via the WAN, communications received from the other communication devices of the second set of communication devices.

Yet another embodiment of the present invention encompasses an apparatus for bridging a PAN with a WAN. The apparatus includes a network-based server comprising a processor and an at least one memory device that is configured to maintain a user account at a network-based server, wherein the user account comprises an identifier of a user, identifiers for each of a plurality of communication devices of the user, and a state of each communication device of the plurality of communication devices. The at least one memory device that is configured to store a set of instructions that, when executed by the processor, cause the processor to perform the following functions: receive a login attempt by a first communication device of the plurality of communication devices; receive, from the first communication device, a request to connect to one or more second communication devices of the plurality of communication devices of the user; determine a state of each of the one or more second communication devices; and based on the determined state of each of the one or more second communication devices, connect the first communication device to at least one of the one or more second communication devices via the server and without authenticating a user of the first communication device.

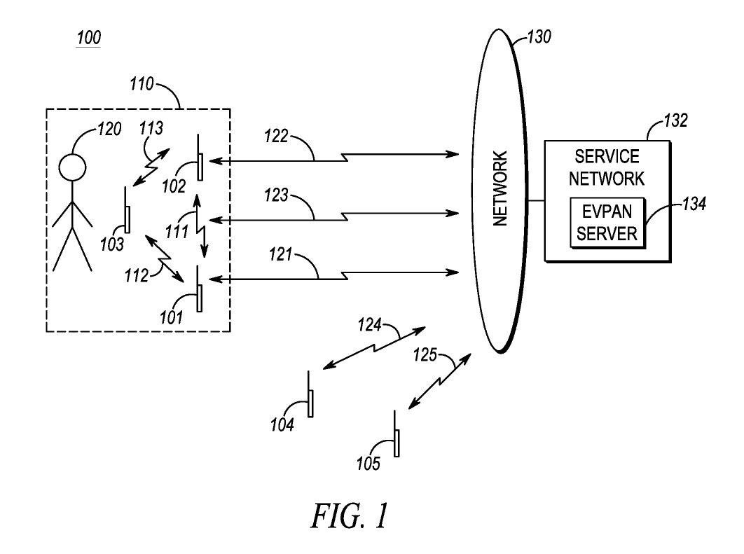

The present invention may be more fully described with reference to FIGS. 1-7. FIG. 1 is a block diagram of a wireless communication system 100 in accordance with some embodiments of the present invention. Communication system 100 includes a first set of multiple end-user communication devices 101-103 (three shown), such as a smart phone, a laptop computer, a land mobile radio (LMR), a tablet, personal data assistant (PDA), or laptop computer with wireless capabilities, or a personal computer. Each of the multiple communication devices 101-103 is configured to operate on a narrowband network or a broadband network and to communicate with infrastructure devices in the corresponding network using any suitable protocol.

In one embodiment, each of the multiple communication devices 101-103 may communicate directly with each other, that is, engage in a peer-to-peer wireless communication with each other, over a Personal Area Network (PAN) 110. For example, as depicted in FIG. 1, a first communication device 101 of the first set of communication device 101-103 communicates with each of a second communication device 102 and a third communication device 103 of the first set of communication device 101-103 via a corresponding wireless link 111 and 112 and the second communication device 102 communicates with the third communication device 103 of the first set of communication device 101-103 via a wireless link 113, wherein each of wireless links 111-113 is a short range wireless link, for example, a Bluetooth or a Wi-Fi link, such as an Institute of Electrical and Electronics Engineers (IEEE) 802.11 link. Each communication device of the first set of multiple communication devices 101-103 also communicates with network devices of a wide area narrowband or broadband network (WAN) 130 via a corresponding wireless link 121-123 and, via WAN 130, with a service network 132, such as a network of an enterprise operator or a public safety agency, and a service network extended virtual PAN (EVPAN) server 134. For example, communication device 101 communicates with WAN 130 via a first wireless link 121, communication device 102 communicates with WAN 130 via a second wireless link 122, and communication device 103 communicates with WAN 130 via a third wireless link 123. In other embodiments of the present invention, one or more communication devices of the first set of multiple communication devices 101-103 may share a same wireless link for communicating with WAN 130.

Communication system 100 further includes a second set of one or more end-user communication devices 104, 105 (two shown) that are outside of the wireless communication range of PAN 110. Each communication device of the second set of one or more communication devices 104, 105 also communicates with infrastructure devices of WAN 130 via a corresponding wireless link 124, 125 and, via WAN 130, with service network 132 and EVPAN server 134. For example, a fourth communication device 104 of the second set of communication devices communicates with WAN 130 via a fourth wireless link 124 and a fifth communication device 105 of the second set of communication devices communicates with WAN 130 via a fifth wireless link 125. In other embodiments of the present invention, one or more communication devices of the second set of one or more communication devices 104, 105 may share a same wireless link for communicating with WAN 130. Communication devices 101-105 belong to a first, same user 120 and may be referred to herein as collaborative devices in that they are able to communicate with each other via an EVPAN as described herein.

In various embodiments of the present invention, WAN 130 need not be a single network as illustrated, but could include multiple wireless networks interconnected by forwarding equipment. In such embodiments, one or more of the multiple communication devices 101-105 may be served by a different wireless network of the multiple wireless networks, and a different wireless service provider, than other communication devices of the multiple communication devices. For example, one of the multiple communication devices 101-105 may be a broadband device that communicates with a broadband wireless network, such as a Third Generation Partnership Project Long Term Evolution (3GPP LTE) network, and another of the multiple communication devices 101-105 may be a narrowband device that communicates with a narrowband wireless network, such as a Public Safety Narrowband (PSNB) network.

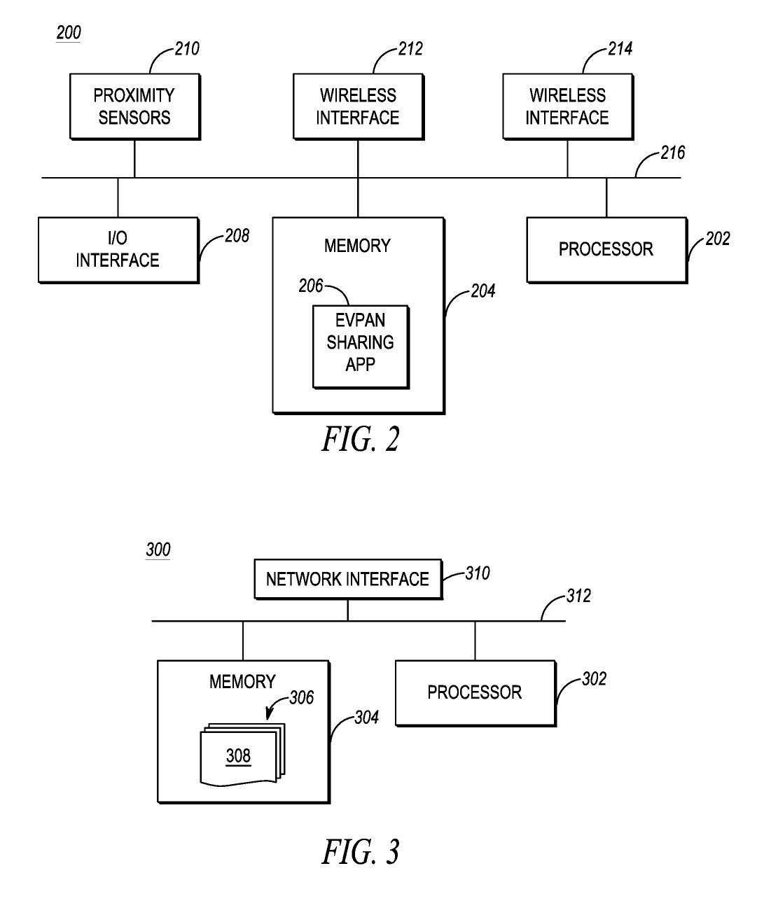

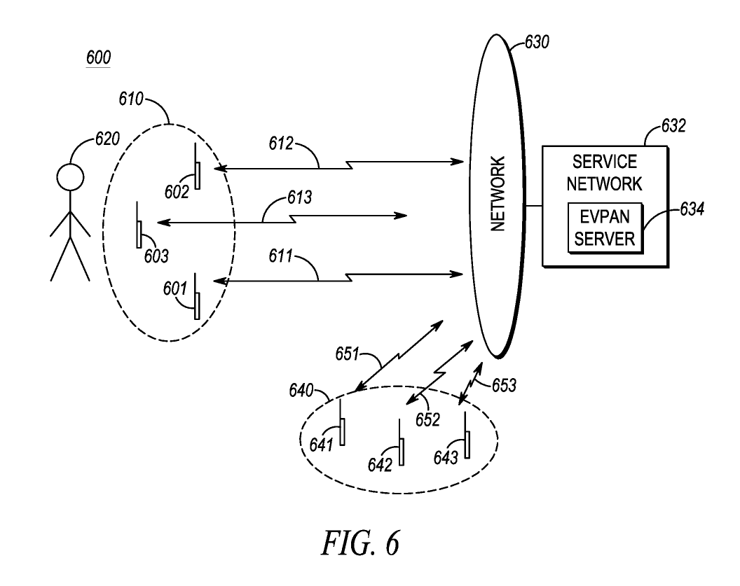

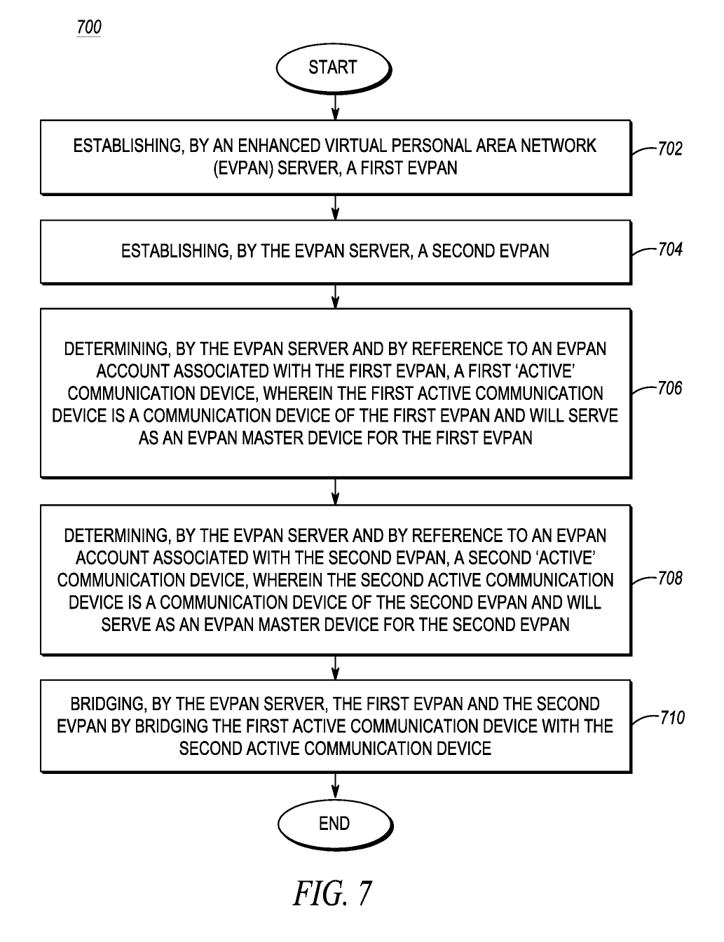

Referring now to FIG. 2, a block diagram of a communication device 200, such as communication devices 101-105 and communication devices 601-603 and 641-643 (referred to with respect to FIGS. 6 and 7), is provided in accordance with some embodiments of the present invention. Communication device 200 generally includes a processor 202, at least one memory device 204, one or more input/output (I/O) interfaces 208, one or more proximity sensors 210 (one shown), and one or more wireless interfaces 212, 214 (two shown). The components (202, 204, 208, 210, 212, 214) of communication device 200 are communicatively coupled via a local interface 216. Local interface 216 can be, for example but not limited to, one or more buses or other wired or wireless connections, as is known in the art. Local interface 216 can have additional elements, which are omitted for simplicity, such as controllers, buffers (caches), drivers, repeaters, and receivers, among many others, to enable communications. Further, local interface 216 may include address, control, and/or data connections to enable appropriate communications among the aforementioned components. It should be appreciated by those of ordinary skill in the art that FIG. 2 depicts communication device 200 in an oversimplified manner, and a practical embodiment may include additional components and suitably configured processing logic to support known or conventional operating features that are not described in detail herein.

Communication device 200 operates under the control of processor 202, such as one or more microprocessors, microcontrollers, digital signal processors (DSPs), combinations thereof or such other devices known to those having ordinary skill in the art. Processor 202 operates the corresponding communication device according to data and instructions stored in the at least one memory device 204, such as random access memory (RAM), dynamic random access memory (DRAM), and/or read only memory (ROM) or equivalents thereof, that stores data and instructions that may be executed by the corresponding processor so that the communication device may perform the functions described herein.

The one or more I/O interfaces 208 include user interfaces that allow a user to input information in, and receive information from, communication device 200. For example, the user interfaces may include a keypad, a touch screen, a scroll ball, a scroll bar, buttons, bar code scanner, and the like. Further, the user interfaces include a display screen, such as a liquid crystal display (LCD), touch screen, and the like for displaying system output. Additionally, the user interfaces can include a microphone via with a user can input audio into the communication device, and a speaker via which the user can receive audio from the communication device. I/O interfaces 208 also can include, for example, a serial port, a parallel port, a small computer system interface (SCSI), an infrared (IR) interface, a universal serial bus (USB) interface, and the like for communicating with, or coupling to, an external device.

The one or more proximity sensors 210 include one or more user proximity sensors that detect whether a user of the communication device is using the communication device or is nearby the communication device, and one or more communication device proximity sensors that detect whether another communication device of the user is nearby. In various embodiments of the present invention, the one or more proximity sensors 210 may be components of communication device 200 that are separate from processor 202 and/or the one or more proximity sensors 210 may be implemented by processor 202.

For example, the one or more user proximity sensors may include an accelerometer that can determine movements of the device, which movements may indicate that the user is currently using the communication device. By way of another example, the one or more user proximity sensors may include a heat sensor that detects the heat of a user's hand that is holding the communication device or the heat of a user's face that is adjacent to the communication device. By way of yet another example, the one or more user proximity sensors may be implementations of processor 202, wherein the processor determines that a user is currently using the communication device, for example, that the user is inputting information via the display screen or the keypad of the communication device or is inputting audio via the microphone of the communication device. For example, an unlocked display screen would be an indication that the user is currently using the communication device. By way of further examples, the one or more communication device proximity sensors may be implementations of processor 202, wherein the processor determines that a collaborative device is nearby based on a successful establishment of a Bluetooth (BT) or a Near Field Communication (NFC) pairing with the collaborative device, or at least based on receiving a BT or Wi-Fi signal of sufficient signal strength from the collaborative device, and further determines a communication device identifier of the nearby collaborative device based on exchanged BT or Wi-Fi signals.

The one or more wireless interfaces 212, 214 facilitate an exchange of wireless communications with other communication devices, such as communication device 101-103 included in PAN 110, and with WAN 130. For example, the one or more wireless interfaces 212, 214 may include a first wireless interface 212 having a transceiver that supports direct communications with other communication devices of PAN 110 via a short-range wireless protocol, such as BT, NFC, or Wi-Fi, and a second wireless interface 212 for communicating with WAN 130 via a WAN protocol.

The data and instructions maintained by at least one memory device 204 include software programs that include an ordered listing of executable instructions for implementing logical functions. For example, the software in at least one memory device 304 includes a suitable operating system (O/S) and programs. The operating system essentially controls the execution of other computer programs, and provides scheduling, input-output control, file and data management, memory management, and communication control and related service. The programs may include various applications, add-ons, etc. configured to provide user functionality with communication device 102. At least one memory device 204 of communication device 200 further maintains an identifier of the communication device as known in the art, for example, a Subscriber Unit ID (SUID), a Mobile Subscriber ISDN Number (MSISDN), an International Mobile Equipment Identity (IMEI), or an International Mobile Subscriber Identity (IMSI), an electronic serial number (ESN), and so on, that may be used to uniquely identify the communication device in communication system 100.

Also, the at least one memory device 204 of communication device 200 may maintain routing information for EVPAN server 134, for example, an Internet Protocol (IP) address and/or a port number of the EVPAN server. In one embodiment of the present invention, the routing address of EVPAN server 134 serves as, or may be included in, an EVPAN identifier maintained by the communication device. For example, EVPAN server 130 may maintain multiple port numbers. Collaborative communication devices, such as communication devices 101-105, may connect to the EVPAN server at a same port and then may be joined by the EVPAN server in an EVPAN. Further, the at least one memory device 204 of communication device 200 may maintain an EVPAN sharing application 206 that engages in a peer-to-peer communication with an EVPAN sharing application 206 of a collaborative communication device and that facilitates an exchange of instructions with the collaborative device so that the communication device can remotely activate and control applications of the collaborative device, such as applications that operate I/O interface 208 elements, such as a display screen and various display screen icons, a microphone, or a speaker, and transmit and receive functionality, of the collaborative device.

Referring now to FIG. 3, a block diagram of an EVPAN server 300, such as EVPAN servers 134 and 634 (referred to with respect to FIGS. 6 and 7), is provided in accordance with some embodiments of the present invention. EVPAN server 300 generally includes a processor 302, at least one memory device 304, and one or more network interfaces 310 (one shown) that provide for an exchange of communications with elements of WAN 130, and via WAN 130, with each of communication devices 101-105. The components (302, 304, 310) of EVPAN server 300 are communicatively coupled via a local interface 312. Local interface 312 can be, for example but not limited to, one or more buses or other wired or wireless connections, as is known in the art. Local interface 312 can have additional elements, which are omitted for simplicity, such as controllers, buffers (caches), drivers, repeaters, and receivers, among many others, to enable communications. Further, local interface 312 may include address, control, and/or data connections to enable appropriate communications among the aforementioned components. It should be appreciated by those of ordinary skill in the art that FIG. 3 depicts EVPAN server 300 in an oversimplified manner, and a practical embodiment may include additional components and suitably configured processing logic to support known or conventional operating features that are not described in detail herein.

EVPAN server 300 operates under the control of processor 302, such as one or more microprocessors, microcontrollers, digital signal processors (DSPs), combinations thereof or such other devices known to those having ordinary skill in the art. Processor 302 operates EVPAN server 300 according to data and instructions stored in the at least one memory device 304, such as random access memory (RAM), dynamic random access memory (DRAM), and/or read only memory (ROM) or equivalents thereof, that stores data and instructions that may be executed by the corresponding processor so that the EVPAN server may perform the functions described herein.

The at least one memory device 304 of EVPAN server 300 further includes multiple EVPAN user accounts 306, that is, an EVPAN user account for each user served by communication system 100, such as an EVPAN user account 308 for user 120. Each of the multiple EVPAN user accounts 306 includes an identifier of a user associated with the account, a list of identifiers of communication devices belonging to, or under the control of, the user, such as communication devices 101-105 with respect to user 120, and, for each such communication device, one or more states of the communication device. The states may include ‘connected,’ that is, the communication device currently has an established connection with the EVPAN server, ‘disconnected,’ that is, the communication device currently does not have an established connection with the EVPAN server, and ‘active,’ that is, the user is reachable via the communication device, for example, the user currently is using the communication device, that the user is sufficiently proximate to the communication device that the user can receive notifications, such as an audio alert, via the communication device, or the communication device is proximate to another, ‘active’ communication device of the user, that is, a collaborative device. A person using a first communication device listed in an EVPAN user account can establish a communication with, and communicate with, a second, ‘active’ communication device listed in that same EVPAN user account and via the EVPAN server without the person having to authenticate himself or herself with communication system 100.

Unless otherwise specified herein, the functionality described herein as being performed by a communication device, such as communication devices 101-105, 601-603, and 641-643, and EVPAN servers 134 and 634, is implemented with or in software programs and instructions stored in the respective at least one memory device 204, 304, of the communication device and EVPAN server and executed by the associated processor 202, 302 of the communication device and EVPAN server.

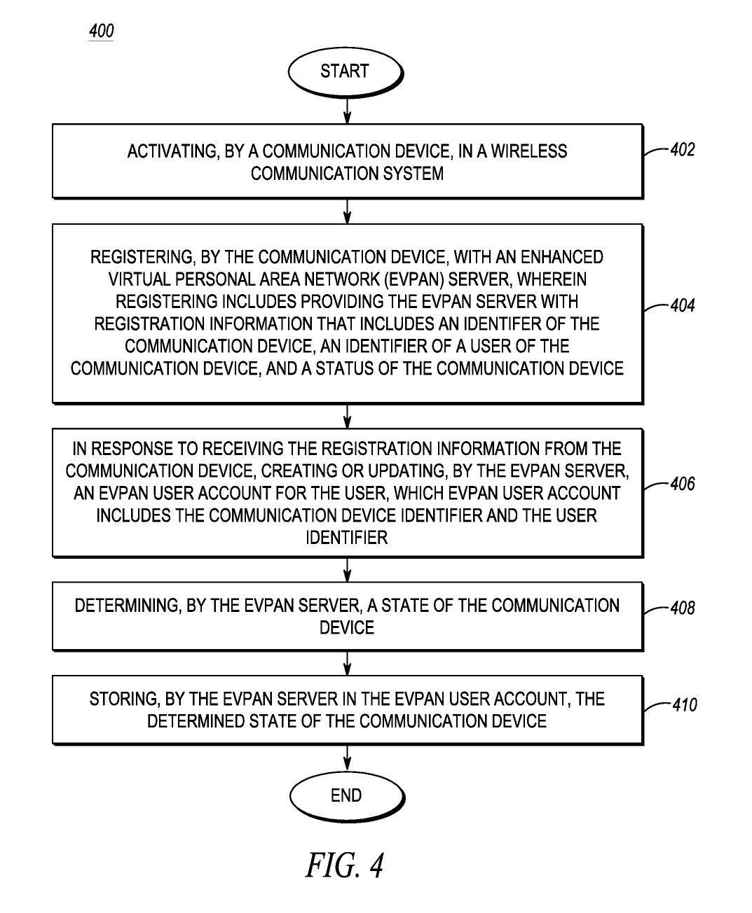

Referring now to FIG. 4, a logic flow diagram 400 is provided that illustrates a method by which a network-based EVPAN user account may be dynamically created on EVPAN server 134 in accordance with some embodiments of the present invention. Logic flow diagram 400 begins when a communication device of user 120, for example, communication device 101, activates (402) in communication system 100 and registers (404) with EVPAN server 134. As part of the registration process, communication device 101 provides EVPAN server 134 with registration information that includes an identifier of the communication device, an identifier of a user of the communication device, that is, user 120, and a status of the communication device.

For example, when user 120 determines to use communication device 101, the user obtains the communication device and inputs an identifier of the user into the communication device. The input may be, for example, a username, a password, a 2-factor authentication, a biometric input, a smart card input and/or another unique identifier associated with the user. The input can also include one or more other factors associated with the user, for example, something that the user knows, something that the user has, and/or something the user is. In some embodiments, receiving an input identifying a user of the communication device forms part of a log-in of the user to the communication device.

In response to receiving the user's input, communication device 101 registers with EVPAN server 134. As part of the registration process, communication device 101 generates registration information, including an identifier of user 120 (a ‘user ID,’ which may or may not be the same as the identifier input by the user into the communication device) that uniquely identifies user 120 in communication system 100, an identifier of communication device 101, such as an IMEI, an MSISDN, and/or an IMSI that is retrieved from at least one memory device 204, and status information for the communication device. Communication device 101 then conveys (408) the registration information to EVPAN server 134.

The status information may include information concerning a current use of the communication device, such as whether the user is currently using the communication device, and proximity information, such as whether the communication device is proximate to the user of the communication device and/or whether the communication device is proximate to another collaborative device. For example, by reference to the one or more proximity sensors 210, such as an accelerometer, the communication device may determine that movements of the device indicate that the user is currently using the communication device. By way of another example, by reference to the one or more proximity sensors 210, such as a heat sensor that detects the heat of a user's hand that is holding the communication device or of a user's face that is adjacent to the communication device, the communication device may determine that the communication device is in current use by the user. By way of yet another example, processor 202 may determine that a display screen is unlocked or that the user is currently inputting information and/or commands via I/O interface 208, such as touching a display screen, again indicating that a user is currently using the communication device. By way of still further examples, processor 202 may determine that a collaborative device is nearby based on a successful establishment of a Bluetooth (BT) or a Near Field Communication (NFC) pairing with the collaborative device, or based on receiving a BT or Wi-Fi signal of sufficient signal strength from the collaborative device. Further, the communication device may receive a communication device identifier from the proximate, that is, nearby, collaborative device based on exchanged BT, NFC, or Wi-Fi signals. In the event that the communication device detects a collaborative device nearby and further receives a communication device identifier from the nearby collaborative device, the status information provided to EVPAN server 134 by the communication device, that is, communication device 101, may include the communication device identifier of the nearby collaborative device.

In response to receiving the registration information from communication device 101, EVPAN server 134 determines whether it maintains an EVPAN user account for the user of the communication device, that is, user 120, and creates or updates (406) the EVPAN user account, whichever is appropriate. That is, EVPAN server 134 checks its list of EVPAN user accounts 306 to determine whether it includes an EVPAN user account for user 120. If the EVPAN server does not maintain an EVPAN user account for user 120, then the EVPAN server creates an EVPAN user account 308 for user 120 and adds the identifier of communication device 101 to the EVPAN user account. If the EVPAN server currently maintains an EVPAN user account 308 for user 120, then EVPAN server 134 updates the EVPAN user account by determining whether the account includes an identifier of communication device 101 and, if not, adds the identifier of communication device 101 to the EVPAN user account. Further, as part of the process of creating or updating the EVPAN user account for user 120, EVPAN server 134 determines (408), based on the provided status information, a state of communication device 101, that is, whether the communication device is connected, disconnected, and/or active, and stores (410) the determined state in EVPAN user account 308 and in association with the identifier of the communication device. Logic flow 400 then ends.

For example, in registering with EVPAN server 134, communication device may establish a connection with the EVPAN server and, accordingly, may be determined by the EVPAN server to be in a ‘connected’ state. Further, the status information included in the registration information may indicate that the communication device is currently being used by the user and that the user is nearby, both of which correspond to an ‘active’ state for communication device 101. Further, as noted above, the status information included in the registration information may indicate that communication device 101 is proximate to another, collaborative device, such as communication devices 102 and 103 with respect to communication device 101. EVPAN server 134 then may check the EVPAN user account for the user of communication device 101 to determine whether the collaborative device, that is, one or more of communication devices 102 and 103, is an ‘active’ communication device, and if so, then communication device 101 may be determined to also be an ‘active’ device, that is, the state of communication device 101 then may be recorded as ‘active.’

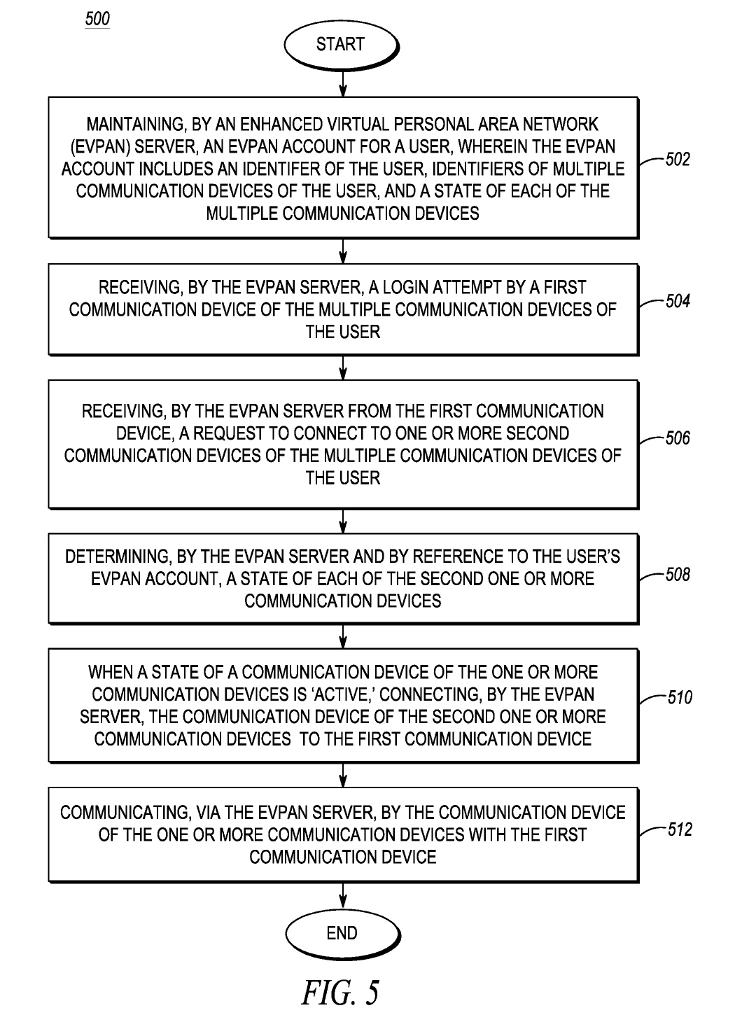

Referring now to FIG. 5, a logic flow diagram 500 is provided that illustrates a method executed by communication system 100 in setting up a network-based EVPAN in accordance with some embodiments of the present invention. Logic flow diagram 500 begins when EVPAN server 134 maintains (502) an EVPAN user account for a user, such as user 120, which EVPAN user account includes an identifier of the user, identifiers for multiple communication devices of the user, such as mobile devices 101-105, and a state of each of the multiple communication devices, such as whether the communication device is ‘connected,’ ‘disconnected,’ and/or ‘active.’ In some embodiments of the present invention, user 120 may manually create the EVPAN user account on EVPAN server 134 and register mobile devices 101-105 in the EVPAN user account. For example, user 120 may log into EVPAN server 134 via a computer device, such as a communication device, a laptop computer, or a personal computer, and manually create the EVPAN user account on EVPAN server 134, including registering each of mobile devices 101-105 in the EVPAN user account. Additionally or instead, in some embodiments of the present invention the EVPAN user account may be dynamically created and/or updated as described with respect to FIG. 4.

At some point in time, one of user 120′s multiple communication devices 101-105, for example, first communication device 101, then attempts to login (504) to EVPAN server 134. In response to receiving the login attempt, EVPAN server 134 may set the state of the communication device to ‘active,’ that is, the EVPAN server may determine that the user is using and/or is proximate to the registering communication device, or the EVPAN server may determine that the registering communication device is proximate to an ‘active’ collaborative device, such as communication devices 102 and 103.

When first communication device 101 then wants to communicate with another communication device of the user, such as one or more second communication devices 102-105, the first communication device may convey to EVPAN server 134, by reference to the EVPAN routing information maintained by the communication device and via air interface 121 and WAN 130, and the EVPAN server receives (506) from the first communication device, a request to connect to the one or more second communication devices 102-105.

In response to receiving the request to connect, EVPAN server 134 interconnects the requesting communication device 101 of user 120 and the one or more second communication devices 102-105 of the same user without requiring that a user of the requesting communication device be authenticated by service network 132. For example, suppose that an unauthenticated, second user picks up communication device 101 at a time that first user 120 is carrying a different communication device 102-105, such as communication device 104, of the multiple communication devices 101-105 of user 120. The unauthenticated second user may be able to reach user 120 on communication device 104 without needing to provide authentication information to EVPAN server 134 subsequent to picking up communication device 101. However, the unauthenticated user may be restricted to using communication device 101 only to communicate with the other communication devices 102-105 of user 120, thereby restricting the unauthenticated user's access to communication system 100.

More particularly, in response to receiving the request to connect from first communication device 101, EVPAN server 134 checks the user's EVPAN user account, that is, EVPAN user account 308, with respect to each of the one or more second communication devices 102-105 to determine (508) a state of each of the one or more second communication devices, that is, to determine whether each of the one or more second communication devices is an ‘active’ communication device. For each of the one or more second communication devices that is listed in the EVPAN user account as being in the ‘active’ state, for example, communication device 102 and 104 (but not communication devices 103 and 105, which may be in a disconnected state or a connected but not active state), EVPAN server 134 then connects (510) first, requesting communication device 101 to such ‘active’ one or more second communication devices 102, 104, and without requiring that a user of the first, requesting communication device be authenticated subsequent to the login attempt of the first, requesting communication device. First communication device 101 then may communicate (512) with each of the one or more ‘active’ second communication devices via WAN 130 and EVPAN server 134, and logic flow diagram 500 then ends.

The EVPAN may be considered to be virtual in that it is transparent, to the users of each of communication devices 101, 102 and 104, that the communication devices are communicating via WAN 130 and EVPAN server 134 and not directly with each other via a PAN, and further in that the user of communication device 101 is not required to authenticate with service network 132. Additionally, the EVPAN is extended in the sense that the EVPAN does not require that the communication devices be within short-range communication distance of each other as is typical for a PAN; for example, the EVPAN includes communication device 104 which is not within sufficient proximity of communication devices 101 and 102 to engage in direct, short-range communications with communication devices 101 and 102.

In some embodiments of the present invention, in connecting the first, requesting communication device 101 to each of the one or more second communication devices 102 and 104, EVPAN server 134 bridges traffic between first communication device 101 and each of the one or more second communication devices 102 and 104 via WAN 130 and their corresponding wireless links 122 and 124. First communication device 101 and each of the one or more second communication devices 102 and 104 then may exchange wireless communications, such as a text message, a video message, or an audio communication, with each other via WAN 130, wireless links 121, 122, and 124, and EVPAN server 134, thus creating an extended virtual PAN (EVPAN) among communication devices 101, 102, and 104.

In some embodiments of the present invention, after connecting the first, requesting communication device 101 to each of the one or more second communication devices 102 and 104, EVPAN server 134 may provide for an information sharing between the connected communication devices that leverages various functionality at each such communication device. That is, after being registered with EVPAN server 134, and assuming that first, requesting communication device 101 is listed as an ‘active’ communication device in user 120′s EVPAN user account, communication device 101 can send to the EVPAN server, via air interface 121 and WAN 130, a request to share an application of one of the one or more second communication devices, such as communication device 104. In response to receiving the request, EVPAN server 134 checks the user's EVPAN user account, that is, EVPAN user account 308, to determine whether communication device 104 is an ‘active’ communication device.

If communication device 104 is listed in the EVPAN user account 308 as an ‘active’ device, then EVPAN server 134 may authorize a sharing, by first communication device 101, of the application of communication device 104. EVPAN server 134 then bridges an exchange of control information between communication device 101 and communication device 104, thereby providing for peer-to-peer communications between the communication devices 101 and 104, whereby an EVPAN sharing application 206 of communication device 101 can communicate with an EVPAN sharing application 206 of communication device 104 in order to control a I/O interface 208 of communication device 104, for example, a display screen, or to control the wireless transmitting and receiving functionality of communication device 104, for example, by originating a call with network 130 and sending and receiving text, video, or audio to and from network 130, via communication device 104.

For example, first communication device 101 may be a computer at the user's office and communication device 104 may be a phone at the user's home. EVPAN server 134 may authorize communication device 101 to share an application of communication device 104 such as a call function, thereby allowing the EVPAN sharing application 206 of the user's computer to originate a call using the user's phone, wherein audio output of the phone is redirected to, and played out by, speaker functionality of the computer and audio input to the computer is redirected to, and then transmitted to WAN 130, by the transceiver functionality of the phone. By way of another example, communication device 101 may be a narrowband communication device and communication device 104 may be a broadband communication device. EVPAN server 134 may authorize the user of communication device 101 to remotely control applications of communication device 104 via communication device 101, for example, to instruct communication device 104 to record a picture or video and then send the picture or video to other communication devices, such as communication devices 102, 103, and 105 (as well as communication device 101) of the user registered in EVPAN user account 308.

Referring now to FIGS. 6 and 7, a method and communication system are provided that illustrate a creation of a super-EVPAN, that is, a bridging of multiple EVPANs via a WAN, in accordance with some embodiments of the present invention. More particularly, FIG. 6 is a block diagram illustration of a super-EVPAN within a wireless communication system 600 in accordance with some embodiments of the present invention. Communication system 600 includes a first set of multiple user-based communication devices 601-603 (three shown) that belong to a same user, that is, user 620, and that are arranged in a first EVPAN 610. Each of the multiple communication devices 601-603 communicates with a WAN 630 via a respective wireless link 611-613 and, via the WAN, with a service network 632, such as a network of an enterprise operator or a public safety agency, and a service network EVPAN server 634. In other embodiments of the present invention, one or more communication devices of the first set of multiple communication devices 601-603 may share a same wireless link for communicating with network devices of WAN 630.

Communication system 600 further includes a second set of multiple user-based communication devices 641-643 (three shown) that also belong to a same user, which user may or may not be user 620, and that are arranged in a second EVPAN 640. Each of the multiple communication devices 641-643 communicates with WAN 630 via a respective wireless link 651-653 and, via the WAN, with service network 632 and EVPAN server 634. In other embodiments of the present invention, one or more communication devices of the first set of multiple communication devices 641-643 may share a same wireless link for communicating with network devices of WAN 630.

Each of communication devices 611-613 and 641-643 is configured to operate on a narrowband network or a broadband network and to communicate with infrastructure devices in the corresponding network using any suitable over-the-air protocol and modulation scheme. Similar to communication system 100, in various embodiments of the present invention, WAN 630 need not be a single network as illustrated, but could include multiple wireless networks interconnected by forwarding equipment. In such embodiments, one or more of the multiple communication devices 601-603 and 641-643 may be served by a different wireless network of the multiple wireless networks, and a different wireless service provider, than other communication devices of the multiple communication devices.

EVPAN server 634 maintains a separate EVPAN user account for each of EVPANs 610 and 640. That is, EVPAN server 634 maintains a first EVPAN user account for EVPAN 610, which EVPAN user account includes a listing of the identifiers, and states, of each of communication devices 601-603, along with an identifier of user associated with communication devices 601-603, that is, user 620. EVPAN server 634 further maintains a second EVPAN user account for EVPAN 640, which EVPAN user account includes a listing of the identifiers, and states, of each of communication devices 641-643, along with an identifier of a user associated with communication devices 641-643.

Communication system 600 operates similarly to communication system 100, wherein each of EVPANs 610 and 640 may operate as similar to the EVPAN described with respect to communication system 100. However, in communication system 600, EVPAN server 634 may create a super-EVPAN by combining EVPAN 610 and EVPAN 640. In creating the super-EVPAN, EVPAN server 634 designates each of a first communication device from the first set of communication devices 601-603, such as communication device 602, and a second communication device from the second set of communication devices 641-643, such as communication device 642, to act as an ‘EVPAN master device.’

The EVPAN master device is an ‘active’ communication device that serves as a relay node for the other communication devices of that EVPAN/set of communication devices, with respect to communicating with WAN 630, and, via the WAN, with service network 632 and EVPAN server 634. The other communication devices of each EVPAN/set of communication devices, that is, communication devices 601 and 603 of the first set of communication devices and communication devices 641 and 643 of the second set of communication devices, then may be referred to as ‘EVPAN slave devices.’

In one embodiment of the present invention, for each of the first set of communication devices and the second set of communication devices, EVPAN server 134 may inform the communication devices which device is the communication EVPAN master device, such as communication device 602 of the first EVPAN/set of communication devices, and which communication devices are the EVPAN slave devices, such as communication devices 601 and 603 of the first EVPAN/set of communication devices. In another embodiment of the present invention, for each of the first set and the second set of communication devices, EVPAN server 134 may inform the EVPAN master device of that set of communication devices that it is designated as the EVPAN master device, and the EVPAN master device then may inform the other communication devices of that set of communication devices that it has been designated the EVPAN master device (and, consequently, they can determine that they are EVPAN slave devices).

EVPAN server 134 may set up the super-EVPAN in response to a receiving a request from a communication device of one EVPAN, such as communication device 601 of first EVPAN 610, to connect to one or more communication devices of another EVPAN, for example, second EVPAN 640. In response to receiving the request, EVPAN server 134 may bridge the two EVPANs to set up a super-EVPAN that comprises EVPAN 610 and EVPAN 640. When bridging the EVPANs, EVPAN server 634 may convey all communications intended for ‘active’ communication devices in first EVPAN 610, such as communication devices 601-603, to EVPAN master device 602, and convey all communications intended for ‘active’ communication devices in second EVPAN 640, that is, communication devices 641-643, to EVPAN master device 642. Each EVPAN master device then may distribute communications received from EPVAN server 134 to the other, EVPAN slave devices of its EVPAN as described with respect to communication system 100, that is, via WAN 630 and EVPAN server 634.

For example, when EVPAN master device 602 receives a communication from EVPAN 640 via EVPAN server 634, EVPAN master device 602 then may relay the communication to slave devices 601 and 603 of EVPAN 610 via WAN 630 and EVPAN server 634. Further, when an EVPAN slave device, such as communication device 601, wishes to convey a communication to EVPAN 640, the EVPAN slave device may convey the communication to EVPAN master device 602 via WAN 630 and EVPAN server 634, and EVPAN master device 602 then may relay the communication to EVPAN 640 via WAN 630 and EVPAN server 634. Similarly, when EVPAN master device 642 receives a communication from EVPAN 610 via EVPAN server 634, EVPAN master device 642 then may relay the communication to slave devices 641 and 643 of EVPAN 640 via WAN 630 and EVPAN server 634. And when an EVPAN slave device, such as communication device 641, wishes to convey a communication to EVPAN 610, the EVPAN slave device may convey the communication to EVPAN master device 642 via WAN 630 and EVPAN server 634, and EVPAN master device 642 then may relay the communication to EVPAN 610 via WAN 630 and EVPAN server 634.

In order to further illustrate the principles of the present invention and referring now to FIG. 7, a logic flow diagram 700 is provided that illustrates the method executed by communication system 600 in creating a super-EVPAN, that is, in bridging EVPANs 610 and 640 via WAN 630, in accordance with some embodiments of the present invention. Logic flow 700 begins when EVPAN server 634 establishes (702) first EVPAN 610, wherein the first EVPAN comprises the first set of communication devices 601-603 that are bridged via WAN 630 and EVPAN server 134. Further, EVPAN server 634 establishes (704) the second EVPAN 640, wherein the EVPAN comprises the second set of communication devices 641-643 that are bridged via WAN 130 and EVPAN server 134.

EVPAN server 634 then determines (706) a first active communication device, such as communication device 602, wherein the first active communication device is a communication device of first EVPAN 610 and will operate as an EVPAN master device for the first EVPAN. EVPAN server 634 further determines (708) a second active communication device, such as communication device 642, wherein the second active communication device is a communication device of second EVPAN 640 and will operate as an EVPAN master device for the second EVPAN. EVPAN server 134 then bridges (710) first EVPAN 610 and second EVPAN 640 by bridging first active communication device 602 with the second active communication device 642, and logic flow diagram 700 then ends.

That is, EVPAN server 134 routes communications, received from second EVPAN 640 and intended for communication devices of first EVPAN 610, to EVPAN master device 602, and EVPAN master device 602 then relays the received communications to the other communication devices 601, 603 of the first EVPAN/set of communication devices via WAN 630 and EVPAN server 634. Further, communication devices 601, 603 of the first EVPAN/set of communication devices route communications intended for second EVPAN 640 to EVPAN master device 602 via WAN 630 and EVPAN server 634, which relays the received communications to second EVPAN 640 via the WAN and EVPAN server. Similarly, EVPAN server 134 routes communications, received from first EVPAN 610 and intended for communication devices of second EVPAN 640, to EVPAN master device 642, and EVPAN master device 642 then relays the received communications to the other communication devices 641, 643 of the second EVPAN/set of communication devices via WAN 630 and EVPAN server 634. And communication devices 641, 643 of the second set of communication devices route communications intended for first EVPAN 610 to EVPAN master device 642 via WAN 630 and EVPAN server 634, which relays the received communications to first EVPAN 610 via the WAN and EVPAN server.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for bridging a Personal Area Network (PAN) with a wide area network (WAN), the method comprising:
maintaining a user account at a network-based server, wherein the user account comprises an identifier of a user, identifiers for each of a plurality of communication devices of the user, and a state of each communication device of the plurality of communication devices;
receiving, by the server, a login attempt by a first communication device of the plurality of communication devices;
receiving, by the server from the first communication device, a request to connect to a second communication device of the plurality of communication devices;
determining, by the server and by reference to the user account, a state of the second communication device;
connecting, by the server and based on the determined state of the second communication device, the first communication device to the second communication device via the server.

2. The method of claim 1, wherein the user is a first user, wherein a user of the first communication device is a second user, wherein the first user is a same user or a different user than the second user, and wherein connecting comprises connecting the first communication device to the second communication device without authenticating the second user subsequent to receiving the login attempt.

3. The method of claim 2, wherein the second user is a different user than the first user.

4. The method of claim 1, wherein connecting comprises bridging traffic between the first communication device and the second communication device.

5. The method of claim 1, wherein connecting comprises bridging an exchange of control information between first communication device and the second communication device, wherein the control information comprises information facilitating a remote control, by the first communication device, of applications of the second communication device.

6. The method of claim 5, wherein the control information comprises information facilitating a remote control of one or more of an input/output interface of the second communication device and wireless transmitting and receiving by the second communication device.

7. The method of claim 5, further comprising:
maintaining, by each of the first communication device and the second communication device, a sharing application that facilitates an exchange of instructions between the first communication device and the second communication device

8. The method of claim 7, further comprising:
remotely activating and controlling, by the first communication device, applications of the second communication device via the sharing applications maintained by the first communication device and the second communication device.

9. The method of claim 1, wherein the determined states comprise one or more of a connected state, a disconnected state, and an active state.

10. The method of claim 9, wherein connecting comprises connecting the first communication device to second communication device in response to determining that the second communication device is in an active state.

11. The method of claim 10, wherein determining that the second communication device is in an active state comprises determining that the user is reachable via the second communication device.

12. The method of claim 11, wherein determining that the user is reachable via the second communication device comprises determining one or more of:
the user currently is using the second communication device;
the user is sufficiently proximate to the second communication device that the user can receive notifications via the second communication device; or
the second communication device is proximate to a communication device of the plurality of communication devices that is in an active state.

13. A method for bridging a plurality of Personal Area Networks with a wide area network (WAN), the method comprising:
establishing a first extended Personal Area Network (PAN), wherein the first extended PAN comprises a first set of communication devices that are bridged via the WAN;
establishing a second extended PAN, wherein the second extended PAN comprises a second set of communication devices that are bridged via the WAN;
determining a first active communication device of the first extended PAN;
determining a second active communication device of the second extended PAN;
bridging the first extended PAN and the second extended PAN by bridging the first active communication device with the second active communication device;
wherein the first active communication device relays, to other communication devices of the first set of communication devices and via the WAN, communications received from the second extended PAN;
wherein the first active communication device relays, to the second extended PAN via the WAN, communications received from the other communication devices of the first set of communication devices;
wherein the second active communication device relays, to other communication devices of the second set of communication devices and via the WAN, communications received from the first extended PAN; and
wherein the second active communication device relays, to the first extended PAN via the WAN, communications received from the other communication devices of the second set of communication devices.

14. An apparatus for bridging a Personal Area Network (PAN) with a wide area network (WAN), the apparatus comprising:
a network-based server comprising:
a processor;
an at least one memory device that is configured to maintain a user account at a network-based server, wherein the user account comprises an identifier of a user, identifiers for each of a plurality of communication devices of the user, and a state of each communication device of the plurality of communication devices, and wherein the at least one memory device further is configured to store a set of instructions that, when executed by the processor, cause the processor to perform the following functions:
receive a login attempt by a first communication device of the plurality of communication devices;
receive, from the first communication device, a request to connect to a second communication device of the plurality of communication devices of the user;
determine, by reference to the user account, a state of the second communication device;
based on the determined state of each of the one or more second communication devices, connect the first communication device to the second communication device via the server.

15. The apparatus of claim 14, wherein the user is a first user, wherein a user of the first communication device is a second user, wherein the first user is a same user or a different user than the second user, and wherein the set of instructions further comprises instructions that, when executed by the processor, cause the processor to connect the first communication device to the second communication device by connecting the first communication device to the second communication device without authenticating the second user subsequent to receiving the login attempt.

16. The apparatus of claim 15, wherein the second user is a different user than the first user.

17. The apparatus of claim 14, wherein the set of instructions further comprises instructions that, when executed by the processor, cause the processor to connect the first communication device to the second communication device by bridging traffic between the first communication device and the second communication device.

18. The apparatus of claim 14, wherein the set of instructions further comprises instructions that, when executed by the processor, cause the processor to connect the first communication device to the second communication device by bridging an exchange of control information between first communication device and the second communication device, wherein the control information comprises information facilitating a remote control, by the first communication device, of applications of the communication device of the second communication device.

19. The apparatus of claim 18, wherein the control information comprises information facilitating a remote control of one or more of an input/output interface of the second communication device and wireless transmitting and receiving by the second communication device.

20. The apparatus of claim 18, further comprising the first communication device and the second communication device, wherein each of the first communication device and the second communication device is configured to maintain a sharing application that facilitates an exchange of instructions between the first communication device and the second communication.

21. The apparatus of claim 20, wherein the first communication device is configured to remotely activate and control applications of the second communication device via the sharing applications maintained by the first communication device and the second communication device.

22. The apparatus of claim 14, wherein the determined states comprise one or more of a connected state, a disconnected state, and an active state.

23. The apparatus of claim 22, wherein the set of instructions further comprises instructions that, when executed by the processor, cause the processor to connect the first communication device to the second communication device by connecting the first communication device to the second communication device in response to determining that the second communication device is in an active state.

24. The apparatus of claim 23, wherein the set of instructions further comprises instructions that, when executed by the processor, cause the processor to determine that the second communication device is in an active state by determining that the user is reachable via the second communication device.

25. The apparatus of claim 24, wherein the set of instructions further comprises instructions that, when executed by the processor, cause the processor to determine that the user is reachable via the second communication device by determining one or more of:
the user currently is using the second communication devices;
the user is sufficiently proximate to the second communication devices that the user can receive notifications via the second communication device; or
the second communication device is proximate to a communication device of the plurality of communication devices that is in an active state.
